(19) United States
(12) Patent Application Publication
(10) Pub. No.: US 2021/0111431 A1
(43) Pub. Date: Apr. 15, 2021

(54) GEL-STATE ELECTROLYTE AND FABRICATING METHOD THEREOF, AND LITHIUM BATTERY

(71) Applicant: NATIONAL CHENG KUNG UNIVERSITY, TAINAN CITY (TW)

(72) Inventors: YU-HSIEN TSENG, TAINAN CITY (TW); YI-HAN SU, TAINAN CITY (TW); YU-CHENG CHEN, TAINAN CITY (TW); YU-SHING LIN, TAINAN CITY (TW); YU-CHENG TSENG, TAINAN CITY (TW); HSISHENG TENG, TAINAN CITY (TW); SHENG-SHU HOU, TAINAN CITY (TW)

(21) Appl. No.: 16/699,739

(22) Filed: Dec. 2, 2019

(30) Foreign Application Priority Data
Oct. 9, 2019 (TW) 108136706

(51) Int. Cl. H01M 10/0565; H01M 10/0567; H01M 10/052

(52) U.S. Cl. CPC H01M 10/0565; H01M 10/052; H01M 10/0567

(57) ABSTRACT

A gel-state electrolyte and a fabricating method thereof, and a lithium battery are described. The fabricating method of the gel-state electrolyte has steps of: adding a polyacrylonitrile type material and a polyalcohol type material to a liquid electrolyte to form a mixture, wherein the liquid electrolyte comprises a lithium salt; performing a crosslinking reaction by heating the mixture to between 70 and 80° C. for more than 4 hours, so as to form a transparent solution; and cooling the transparent solution to form the gel-state electrolyte. The fabricating method has a simple production process.

### CROSS REFERENCE TO RELATED APPLICATION

This application claims priority to Taiwan Patent Application No. 108136706, filed on Oct. 9, 2019, which is incorporated herein by reference in its entirety.

### FIELD OF DISCLOSURE

The present disclosure relates to batteries, and more particularly to a gel-state electrolyte and a fabricating method thereof, and a lithium battery.

### BACKGROUND OF DISCLOSURE

There have been many studies in the field of batteries. For example, an article published in the Journal of Power Sources on Sep. 1, 2019, entitled “A new mechanism for interpreting the effect of TiO₂ nanofillers in quasi-solid-state dye-sensitized solar cells (Liu et al). Or, an article published in Journal of Materials Chemistry in January 2017, entitled “High-performance printable electrolytes for dye-sensitized solar cells.”

In recent years, lithium batteries have been widely used in a variety of electronic products, electric vehicles, or energy storage devices. Therefore, many studies focus on improving performance, energy density, and safety of the energy storage devices. In terms of safety, liquid electrolytes used in lithium batteries tend to have a risk of leakage so as to cause an explosion.

Therefore, it is necessary to provide a gel-state electrolyte and a fabricating method thereof, and a lithium battery to solve problems of the conventional technology.

### SUMMARY OF DISCLOSURE

An object of the present disclosure is to provide a fabricating method of a gel-state electrolyte, in which a crosslinking reaction is performed by adding at least two kinds of polymers (for example, polyacrylonitriles and polyalcohols) into a liquid electrolyte having a lithium salt, so as to form a gel-state electrolyte. The production process of the gel-state electrolyte is simple.

Another object of the present disclosure is to provide a gel-state electrolyte comprising a crosslinked composition formed of a polyacrylonitrile type material, a polyalcohol type material, and a lithium salt. The gel-state electrolyte can be used as an electrolyte of a lithium battery.

A further object of the present disclosure is to provide a lithium battery comprising a gel-state electrolyte of the present disclosure, which can avoid a leakage risk of liquid electrolyte. Further, the lithium battery has excellent battery characteristics.

To achieve the above object, the present disclosure provides a fabricating method of a gel-state electrolyte, comprising steps of: adding a polyacrylonitrile type material and a polyalcohol type material into a liquid electrolyte to form a mixture, wherein the liquid electrolyte comprises a lithium salt; performing a crosslinking reaction of heating the mixture to between 70 and 80° C. for more than 4 hours, so as to form a transparent solution; and cooling the transparent solution to form the gel-state electrolyte.

In an embodiment of the present disclosure, the polyacrylonitrile type material is selected from a group consisting of polyacrylonitrile and derivatives thereof.

In an embodiment of the present disclosure, the polyacrylonitrile type material comprises polyacrylonitrile-methyl acrylate.

In an embodiment of the present disclosure, the polyalcohol type material comprises polyethylene glycol.

In an embodiment of the present disclosure, the polyacrylonitrile type material and the polyalcohol type material has a weight ratio between 10:1 and 20:1.

In an embodiment of the present disclosure, the lithium salt comprises at least one of lithium bistrifluoromethylsulfonimide (LiTFSI), LiPF₆, LiClO₄, LiSO₄, and LiBF₄.

To achieve another object, the present disclosure provides a gel-state electrolyte comprising a crosslinked composition formed of a polyacrylonitrile type material, a polyalcohol type material, and a lithium salt.

To achieve a further object, the present disclosure provides a lithium battery, comprising: a positive electrode material, a negative electrode material, and a gel-state electrolyte. The gel-state electrolyte is disposed between the positive electrode material and the negative electrode material, wherein the gel-state electrolyte comprises a crosslinked composition formed of a polyacrylonitrile type material, a polyalcohol type material, and a lithium salt.

In an embodiment of the present disclosure, the positive electrode material comprises at least one of LiCoO₂, ternary materials, and LiFePO₄.

In an embodiment of the present disclosure, the negative electrode material comprises at least one of graphite, lithium titanium oxide, and lithium metal.

### DESCRIPTION OF DRAWINGS

FIG. 1 is a flowchart showing a fabricating method of a gel-state electrolyte according to an embodiment of the present disclosure.

FIG. 2 is an exploded diagram showing a lithium battery according to an embodiment of the present disclosure.

FIG. 3 is a schematic diagram showing an analysis of a charge and discharge test of a lithium battery of Embodiment 1 at room temperature (25° C.).

### DETAILED DESCRIPTION OF PREFERRED EMBODIMENTS

The structure and the technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, and etc., are only directions by referring to the accompanying drawings, and thus the used directional terms are used to describe and understand the present disclosure, but the present disclosure is not limited thereto.

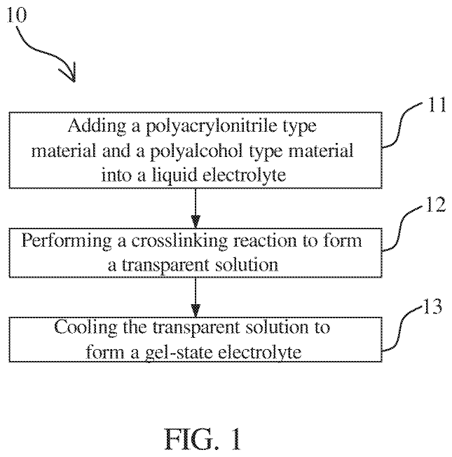

Referring to FIG. 1, an embodiment of the present disclosure provides a fabricating method 10 of a gel-state electrolyte mainly comprising steps 11 to 13 of: adding a polyacrylonitrile type material and a polyalcohol type material into a liquid electrolyte to form a mixture, wherein the liquid electrolyte comprises a lithium salt (step 11); performing a crosslinking reaction of heating the mixture to between 70 and 80° C. for more than 4 hours, so as to form a transparent solution (step 12); and cooling the transparent solution to form the gel-state electrolyte (step 13). Details of the implementation and principles of the above-described steps of embodiments will be described in detail below.

In an embodiment of the present disclosure, the fabricating method 10 of the gel-state electrolyte has a step 11 of adding a polyacrylonitrile type material and a polyalcohol type material into a liquid electrolyte to form a mixture, wherein the liquid electrolyte comprises a lithium salt. In the step 11, it is mainly through addition of specific polymer species to the liquid electrolyte containing the lithium salt, so that the liquid electrolyte can form gel-state electrolyte in a subsequent step. In an embodiment, the polyacrylonitrile type material is selected from a group consisting of polyacrylonitrile and derivatives thereof. In an example, the polyacrylonitrile type material comprises polyacrylonitrile-methyl acrylate. In another embodiment, the polyalcohol type material comprises polyethylene glycol. In a further embodiment, the polyacrylonitrile type material and the polyalcohol type material has a weight ratio between 10:1 and 20:1. In an example, the weight ratio can be 11:1, 12:1, 13:1, 14:1, 15:1, 16:1, 17:1, 18:1, or 19:1. In still another embodiment, a weight ratio of a total of the polyacrylonitrile type material and the polyalcohol type material to the liquid electrolyte (i.e., (polyacrylonitrile type material+polyalcohol type material): liquid electrolyte) is between 2:100 and 5:100. In an example, the weight ratio is 3:100 or 4:100. In an embodiment, the lithium salt comprises at least one of lithium bistrifluoromethylsulfonimide (LiTFSI), LiPF₆, LiClO₄, LiSO₄, and LiBF₄.

In an embodiment of the present disclosure, the fabricating method 10 of the gel-state electrolyte has a step 12 of performing a crosslinking reaction of heating the mixture to between 70 and 80° C. for more than 4 hours, so as to form a transparent solution. In the step 12, it is mainly to improve a uniform dissolution of the polyacrylonitrile type material and the polyalcohol type material in the liquid electrolyte by heating, so as to improve the crosslinking reaction. In an embodiment, a heating time of the crosslinking reaction is, for example, 4 to 12 hours. In an example, the heating time is, for example, 5, 6, 7, 8, 9, 10, or, 11 hours.

In an embodiment of the present disclosure, the fabricating method 10 of the gel-state electrolyte has a step 13 of cooling the transparent solution to form the gel-state electrolyte. In the step 13, the transparent solution can be formed into a gel-state electrolyte, for example, by standing and air cooling.

It is noted that at least one feature of the fabricating method of the gel-state electrolyte according to an embodiment of the present disclosure is that at least the polyacrylonitrile type material and the polyalcohol type material need to be added to crosslink the lithium salt to obtain the gel-state electrolyte, so as to avoid the leakage problem caused by the liquid electrolyte. In the case where only the polyacrylonitrile type material is added to carry out a crosslinking reaction with a lithium salt, the liquid electrolyte cannot be formed into a gel-state state. Similarly, in the case where only the polyol is added to carry out a crosslinking reaction with a lithium salt, the liquid electrolyte cannot be formed into a gel-state electrolyte. Further, in the case where a polymer has both an ester functional group and an alcohol functional group, and only the polymer is cross-linked with a lithium salt, the liquid electrolyte cannot be formed into a gel-state electrolyte.

An embodiment of the disclosure provides a gel-state electrolyte comprising a crosslinked composition formed of a polyacrylonitrile type material, a polyalcohol type material, and a lithium salt. In one embodiment, the gel-state electrolyte can be fabricated by the fabricating method of a gel-state electrolyte of an embodiment of the present disclosure. In another embodiment, the crosslinked composition has a three-dimensional network crosslinked structure, wherein the crosslinked structure can destroy an ordered arrangement of the original polymer (for example, the polyacrylonitrile type material or the polyalcohol type material), such that a crystallinity of the polymer is suppressed. Further, a degree of entanglement between the polymers is improved thereby improving a mechanical strength of the gel-state electrolyte. In other words, the crosslinked composition of the gel-state electrolyte is neither a copolymerized polymer (formed by polymerization of a monomer having two or more kinds of specific functional groups), nor a graft type polymer (grafting a polymer with a smaller molecular weight to a polymer main chain).

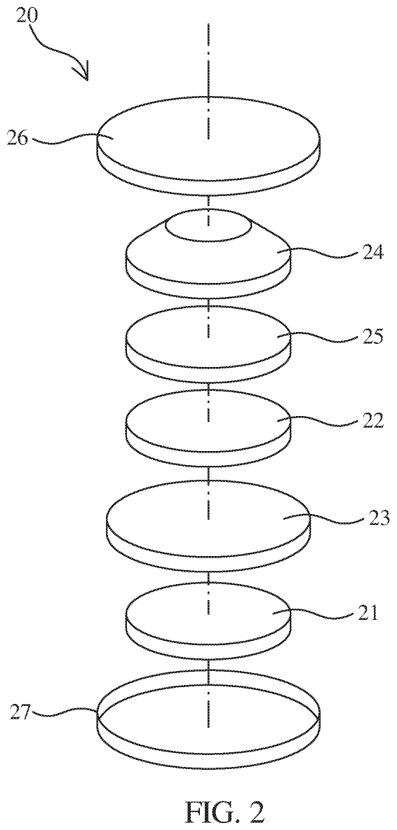

Referring to FIG. 2, an embodiment of the disclosure provides a lithium battery 20 comprising: a positive electrode material 21 and a negative electrode material 22; and a gel-state electrolyte 23. The gel-state electrolyte 23 is disposed between the positive electrode material 21 and the negative electrode material 22, wherein the gel-state electrolyte 23 comprises a crosslinked composition formed of a polyacrylonitrile type material, a polyalcohol type material, and a lithium salt. In an embodiment, the positive electrode material 21 comprises at least one of LiCoO₂, ternary materials, and LiFePO₄. In an embodiment, the negative electrode material 22 comprises at least one of graphite, lithium titanium oxide, and lithium metal. In still another embodiment, the gel-state electrolyte 23 can be produced by a fabricating method of a gel-state electrolyte of an embodiment of the present disclosure. In still another embodiment, the gel-state electrolyte 23 can be a gel-state electrolyte of an embodiment of the disclosure.

In an embodiment, a specific structure of the lithium battery 20 can further include a reed 24 and a tin plate 25. For example, each component in the lithium battery 20 is sequentially assembled into an upper casing 26, the reed 24, the tin piece 25, the negative electrode material 22, the gel-state electrolyte 23, the positive electrode material 21, and a lower case 27.

An embodiment and several comparative examples are set forth below to illustrate that a fabricating method of a gel-state electrolyte according to an embodiment of the present disclosure can indeed fabricate a gel-state electrolyte, and a lithium battery with the gel-state electrolyte has excellent battery characteristics.

### Embodiment 1

0.057 g of polyacrylonitrile-methyl acrylate and 0.003 g of polyethylene glycol are added into 2 g of liquid electrolyte to form a mixture, wherein a weight ratio of cyano groups (C≡N) and methyl acrylate groups (C(═O)OCH₃) of the polyacrylonitrile-methyl acrylate is about 94:6. The liquid electrolyte has 1 M of LiPF₆ in ethylene carbonate (EC) and dimethyl carbonate (DMC) in a volume ratio of 1:1. Next, the mixture is heated to between 70 and 80° C. for more than 4 hours to form a transparent solution. Then, the transparent solution is cooled by standing at room temperature to form the electrolyte of Embodiment 1.

### COMPARATIVE EXAMPLES 1 TO 3

Comparative examples 1 to 3 are produced in substantially the same manner as in Embodiment 1, except that types of substances added to the liquid electrolyte are inconsistent, which is shown in Table 1.

TABLE 1

| | | whether a gel- |
|---|---|---|
| | | state electrolyte |
| | additive | is formed? |
| Embodiment 1 | Polyacrylonitrile-methyl acrylate and | Yes |
| | polyethylene glycol (0.06 g in total) | |
| Comparative | polyacrylonitrile-methyl acrylate | No, a liquid |
| example 1 | (0.06 g) | electrolyte |
| Comparative | polyethylene glycol (0.06 g) | No, a liquid |
| example 2 | | electrolyte |
| Comparative | polymer copolymer of acrylonitrile | No, a liquid |
| example 3 | main-body and ethylene glycol | electrolyte |
| | sub-body (0.06 g) | |

It can be seen from the above Table 1 that the polyacrylonitrile type material and the polyalcohol type material need to be added together to carry out crosslinking reaction with the lithium salt to obtain a gel-state electrolyte.

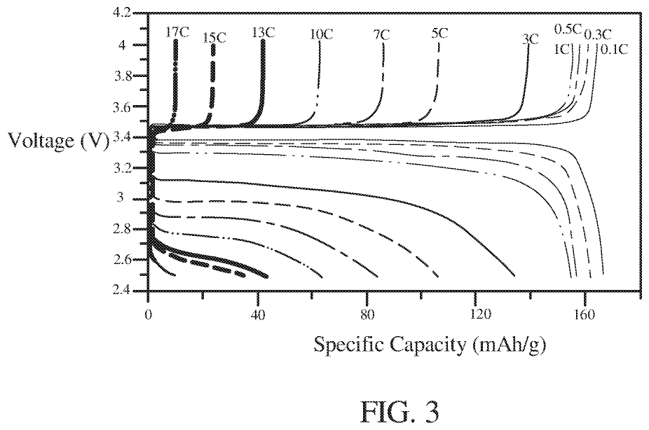

Then, the gel-state electrolyte of Embodiment 1 is combined with a lithium iron phosphate positive electrode and a lithium metal negative electrode to form a lithium battery, and the lithium battery is subjected to a charge and discharge test at room temperature (about 25° C.). A result is shown in FIG. 3. As can be seen from FIG. 3, the lithium battery has a capacitance of about 167 mAh/g at a discharge rate of 0.1 C-rate. At a discharge rate of 17 C-rate, the lithium battery has a capacitance of about 10 mAh/g. The battery characteristics of the lithium battery meet or exceed standards of commercial lithium batteries.

The present disclosure has been described with a preferred embodiment thereof and it is understood that many changes and modifications to the described embodiment can be carried out without departing from the scope and the spirit of the disclosure that is intended to be limited only by the appended claims.

1. A fabricating method of a gel-state electrolyte, comprising steps of:
adding a polyacrylonitrile type material and a polyalcohol type material into a liquid electrolyte to form a mixture, wherein the liquid electrolyte comprises a lithium salt;
performing a crosslinking reaction of heating the mixture to between 70 and 80° C. for more than 4 hours, so as to form a transparent solution; and
cooling the transparent solution to form the gel-state electrolyte.

2. The fabricating method of the gel-state electrolyte according to claim 1, wherein the polyacrylonitrile type material is selected from a group consisting of polyacrylonitrile and derivatives thereof.

3. The fabricating method of the gel-state electrolyte according to claim 1, wherein the polyacrylonitrile type material comprises polyacrylonitrile-methyl acrylate.

4. The fabricating method of the gel-state electrolyte according to claim 1, wherein the polyalcohol type material comprises polyethylene glycol.

5. The fabricating method of the gel-state electrolyte according to claim 1, wherein the polyacrylonitrile type material and the polyalcohol type material has a weight ratio between 10:1 and 20:1.

6. The fabricating method of the gel-state electrolyte according to claim 1, wherein the lithium salt comprises at least one of lithium bistrifluoromethylsulfonimide (LiTFSI), LiPF₆, LiClO₄, LiSO₄, and LiBF₄.

7. A gel-state electrolyte, comprising a crosslinked composition formed of a polyacrylonitrile type material, a polyalcohol type material, and a lithium salt.

8. A lithium battery, comprising:
a positive electrode material and a negative electrode material; and
a gel-state electrolyte disposed between the positive electrode material and the negative electrode material, wherein the gel-state electrolyte comprises a crosslinked composition formed of a polyacrylonitrile type material, a polyalcohol type material, and a lithium salt.

9. The lithium battery according to claim 8, wherein the positive electrode material comprises at least one of LiCoO₂, ternary materials, and LiFePO₄.

10. The lithium battery according to claim 8, wherein the negative electrode material comprises at least one of graphite, lithium titanium oxide, and lithium metal.
